(19) United States
(12) Patent Application Publication
(10) Pub. No.: US 2020/0057325 A1
(43) Pub. Date: Feb. 20, 2020

(54) LIQUID CRYSTAL DISPLAY PANEL

(71) Applicant: Chunghwa Picture Tubes, LTD., Taoyuan City (TW)

(72) Inventors: Yu-Fang Wang, Taoyuan City (TW); Wen-Cheng Lu, Taipei City (TW); Ming-Hua Yeh, Taipei City (TW)

(73) Assignee: Chunghwa Picture Tubes, LTD., Taoyuan City (TW)

(21) Appl. No.: 16/163,595

(22) Filed: Oct. 18, 2018

(30) Foreign Application Priority Data
Aug. 20, 2018 (CN) 201810946726.2

(51) Int. Cl. G02F 1/1339; G02F 1/1333

(52) U.S. Cl. CPC G02F 1/1339; G02F 1/133305

(57) ABSTRACT

A liquid crystal display (LCD) panel adapted to alleviate the separation issue between the pixel array substrate and the opposite substrate is provided. The LCD panel includes a pixel array substrate, a first sealant pattern, a liquid crystal layer, a second sealant pattern and an opposite substrate. The pixel array substrate has an active region and a peripheral region surrounding the active region. The first sealant pattern surrounds the active region. The liquid crystal layer is located on the active region and is located inside the first sealant pattern. The second sealant pattern is located outside the first sealant pattern, and the second sealant pattern includes at least one two-dimensional extending structure. The at least one two-dimensional extending structure is located outside a sidewall corresponding to the first sealant pattern, and includes a plurality of turning structures. The opposite substrate faces the pixel array substrate.

### CROSS-REFERENCE TO RELATED APPLICATION

This application claims the priority benefit of China application serial no. 201810946726.2, filed on Aug. 20, 2018. The entirety of the above-mentioned patent application is hereby incorporated by reference herein and made a part of this specification.

### BACKGROUND OF THE INVENTION

### Field of the Invention

The invention relates to a liquid crystal display (LCD) panel having a first sealant pattern and a second sealant pattern.

### Description of Related Art

Generally speaking, LCDs can be classified into hard LCDs and flexible LCDs according to whether they are easily bent or not. The LCD includes two substrates and a liquid crystal that is located between the two substrates. The substrate of the hard LCD is mainly made of glass, and the substrate of the flexible LCD is mainly made of a plastic material. Whether in hard or flexible LCDs, the two substrates need to be glued to each other by a sealant.

In the case of the flexible LCD, since the panel may be bent upward or downward, or even bent in up and down and left and right directions, the stress applied to the sealant, in addition to shear force, further includes up and down or left and right pulling stresses. Therefore, due to the bending or distortion of the panel, the adhesion of the sealant may be weakened so as to cause the separation issue between the upper and lower plastic substrates.

### SUMMARY OF THE INVENTION

The invention aims at an LCD panel having a first sealant pattern and a second sealant pattern.

The invention provides an LCD panel including a pixel array substrate, a first sealant pattern, a liquid crystal layer, a second sealant pattern and an opposite substrate. The pixel array substrate has an active region and a peripheral region surrounding the active region. The first sealant pattern surrounds the active region. The liquid crystal layer is located on the active region and is located inside the first sealant pattern. The second sealant pattern is located outside the first sealant pattern, and the second sealant pattern includes at least one two-dimensional extending structure. The at least one two-dimensional extending structure is located outside a corresponding sidewall of the first sealant pattern, and includes a plurality of turning structures. The opposite substrate faces the pixel array substrate. The liquid crystal layer, the first sealant pattern and the second sealant pattern are located between the pixel array substrate and the opposite substrate.

In an embodiment of the invention, each of the plurality of turning structures includes a first extending portion and a second extending portion connected to the first extending portion, and an extending direction of the first extending portion and an extending direction of the second extending portion are different from an extending direction of the corresponding sidewall.

In an embodiment of the invention, the extending direction of the first extending portion forms an angle of 45 degrees with the extending direction of the corresponding sidewall, and the extending direction of the second extending portion forms an angle of 135 degrees with the extending direction of the corresponding sidewall.

In an embodiment of the invention, each of the plurality of turning structures includes an X-shape.

In an embodiment of the invention, each of the plurality of turning structures includes a T-shape.

In an embodiment of the invention, the plurality of turning structures are connected together.

In an embodiment of the invention, the LCD panel further includes a third sealant pattern. The third sealant pattern is located outside the second sealant pattern, wherein the third sealant pattern surrounds the first sealant pattern.

In an embodiment of the invention, the LCD panel further includes a third sealant pattern. The third sealant pattern is located outside the second sealant pattern, wherein the third sealant pattern includes a plurality of line segments separated from each other.

In an embodiment of the invention, the pixel array substrate and the opposite substrate comprise flexible substrates.

Based on the foregoing description, since the second sealant pattern has the two-dimensional extending structure, the separation issue between the pixel array substrate and the opposite substrate due to the bending and distortion of the LCD panel may be alleviated. In addition, since the second sealant pattern is located outside the first sealant pattern, the one drop filling (ODF) process may have a better process window.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic top view of an LCD panel according to an embodiment of the invention.

FIG. 2 is a schematic cross-sectional view taken along the line AA′ of FIG. 1.

FIG. 3 is a schematic top view of an LCD panel according to an embodiment of the invention.

FIG. 4 is a schematic top view of an LCD panel according to an embodiment of the invention.

FIG. 5 is a schematic top view of an LCD panel according to an embodiment of the invention.

FIG. 6 is a schematic top view of an LCD panel according to an embodiment of the invention.

FIG. 7 is a schematic top view of an LCD panel according to an embodiment of the invention.

FIG. 8 is a schematic top view of an LCD panel according to an embodiment of the invention.

FIG. 9 is a schematic top view of an LCD panel according to an embodiment of the invention.

### DESCRIPTION OF THE EMBODIMENTS

Descriptions of the invention are given with reference to the exemplary embodiments illustrated by the figures. Wherever possible, the same reference numerals are used in the figures and the description to refer to the same or similar parts.

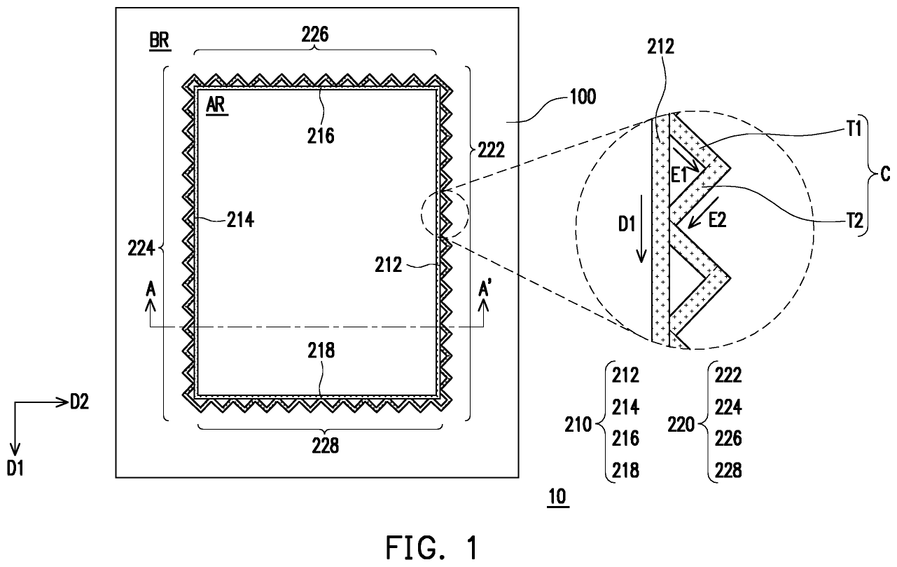

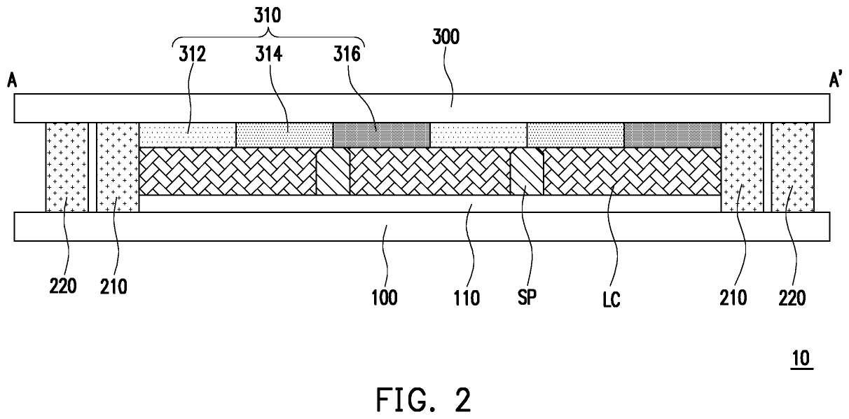

FIG. 1 is a schematic top view of an LCD panel according to an embodiment of the invention. FIG. 2 is a schematic cross-sectional view taken along the line AA′ of FIG. 1. FIG. 1 illustrates a pixel array substrate 100, a first sealant pattern 210 and a second sealant pattern 220, and other components are omitted.

Referring to FIG. 1 and FIG. 2, an LCD panel 10 includes the pixel array substrate 100, the first sealant pattern 210, a liquid crystal layer LC, the second sealant pattern 220 and an opposite substrate 300.

The pixel array substrate 100 includes a flexible substrate, for example. The pixel array substrate 100 has an active region AR and a peripheral region BR surrounding the active region AR. The active device array 110 is, for example, located on the active region AR. The active device array 110 includes, for example, a plurality of scan lines, a plurality of data lines and a plurality of pixel structures. In some embodiments, the pixel array substrate 100 further includes a common electrode thereon, but the invention is not limited thereto. In some other embodiments, the common electrode is located on the opposite substrate 300. The peripheral region BR includes a driving circuit thereon, for example, but the invention is not limited thereto.

The first sealant pattern 210 and the second sealant pattern 220 are located on the pixel array substrate 100. The first sealant pattern 210 and the second sealant pattern 220 are located on the peripheral region BR. The coating of the first sealant pattern 210 and the second sealant pattern 220 may be accomplished by using a sealant coating nozzle or by performing a screen-printing process.

The first sealant pattern 210 is formed by continuous coating, and the first sealant pattern 210 surrounds the active region AR. In this embodiment, the first sealant pattern 210 includes four sidewalls 212, 214, 216 and 218. The sidewalls 212 and 214 extend in a first direction D1, and the sidewalls 216 and 218 extend in a second direction D2. In other embodiments, the first sealant pattern 210 may have different numbers of sidewalls depending on actual needs.

The second sealant pattern 220 is located outside the first sealant pattern 210, and the second sealant pattern 220 includes at least one two-dimensional extending structure, e.g., two-dimensional extending structures 222, 224, 226 and 228. Coating the second sealant pattern 220 in a meandering manner may increase the adhesion of the second sealant pattern 220 in all directions, so that the second sealant pattern 220 may resist the stress caused by the bending of the LCD panel 10 in all directions. In this embodiment, the second sealant pattern 220 includes the four two-dimensional extending structures 222, 224, 226 and 228. Each of the two-dimensional extending structures 222, 224, 226 and 228 is disposed to one of the corresponding sidewalls 212, 214, 216 and 218 of the first sealant pattern 210, and the two-dimensional extending structures 222, 224, 226 and 228 are located outside the corresponding sidewalls 212, 214, 216 and 218 respectively. In this embodiment, the second sealant pattern 220 is connected to the first sealant pattern 210. For example, the two-dimensional extending structures 222, 224, 226 and 228 are connected to the corresponding sidewalls 212, 214, 216 and 218 respectively.

Each of the two-dimensional extending structure 222, 224, 226 and 228 includes a plurality of turning structures C. Taking the two-dimensional extending structure 222 corresponding to the sidewall 212 as an example, the turning structure C includes a first extending portion T1 and a second extending portion T2 connected to the first extending portion T1. At least one of the extending direction E1 of the first extending portion T1 and the extending direction E2 of the second extending portion T2 is different from the extending direction D1 of the sidewall 212. In this embodiment, the extending direction E1 of the first extending portion T1 and the extending direction E2 of the second extending portion T2 are different from the extending direction D1 of the sidewall 212. The extending direction E1 of the first extending portion T1 forms an angle of 90 degrees, for example, with the extending direction E2 of the second extending portion T2. However, the invention is not limited thereto. In some embodiments, the extending direction E1 of the first extending portion T1 forms an angle of 45 degrees with the extending direction D1 of the sidewall 212, and the extending direction E2 of the second extending portion T2 forms an angle of 135 degrees with the extending direction D1 of the sidewall 212. However, the present invention is not limited thereto.

In this embodiment, each of the two-dimensional extending structures 222, 224, 226 and 228 includes a sawtooth shape, but the invention is not limited thereto. In other embodiments, each of the two-dimensional extending structures 222, 224, 226 and 228 includes a wavy shape, i.e., the turning structure C may also be in an arc shape.

The liquid crystal layer LC is located on the active region AR and is located inside the first sealant pattern 210. The liquid crystal layer LC, the first sealant pattern 210 and the second sealant pattern 220 are located between the pixel array substrate 100 and the opposite substrate 300.

The opposite substrate 300 includes a flexible substrate, for example. The opposite substrate 300 faces the pixel array substrate 100. In this embodiment, the opposite substrate 300 has a color filter layer 310 thereon, and the color filter layer 310 includes a red filter pattern 312, a green filter pattern 314, and a blue filter pattern 316. However, the invention is not limited thereto, and the color filter layer 310 may further include filter patterns of other colors. In some embodiments, a black matrix may exist between the filter patterns of different colors, but the invention is not limited thereto. In other embodiments, the color filter layer 310 is located on the pixel array substrate 100 to form a structure of color filter on array (COA).

In this embodiment, the LCD panel 10 selectively includes a spacer SP. The spacer SP is located between the pixel array substrate 100 and the opposite substrate 300, for example, and may be used to control the thickness of the liquid crystal layer LC.

Based on the foregoing description, since the second sealant pattern has two-dimensional extending structure, the separation issue between the pixel array substrate and the opposite substrate due to the bending and distortion of the LCD panel may be alleviated. In addition, since the second sealant pattern is located outside the first sealant pattern, the one drop filling (ODF) process may have a better process window.

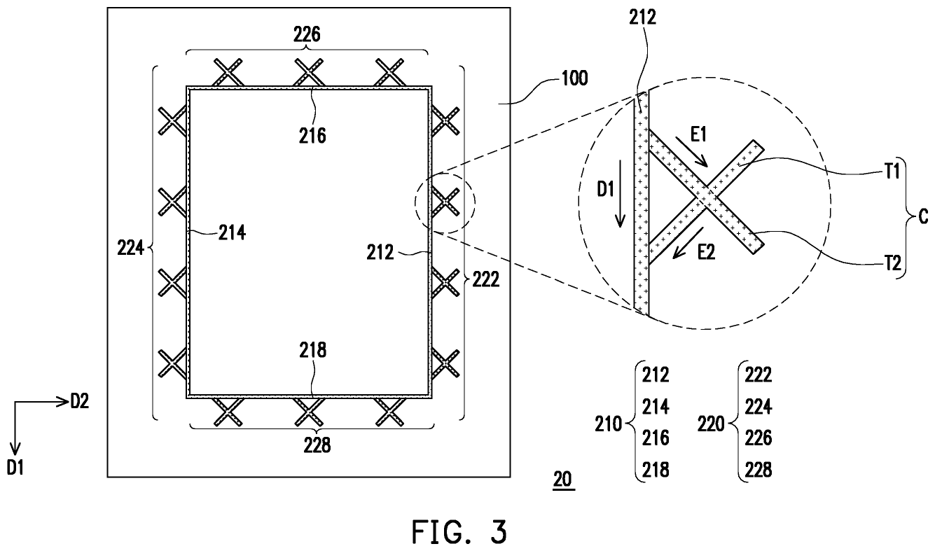

FIG. 3 is a schematic top view of an LCD panel according to an embodiment of the invention. The reference numerals and a part of the content of the embodiment in FIG. 1 are used in the embodiment of FIG. 3, in which identical or similar reference numerals indicate identical or similar components, and repeated description of the same technical content is omitted.

A difference between an LCD panel 20 in FIG. 3 and the LCD panel 10 in FIG. 1 is that a turning structure C of the LCD panel 20 includes an X-shape.

Referring to FIG. 3, in this embodiment, two-dimensional extending structures 222, 224, 226 and 228 of a second sealant pattern 220 each include a plurality of X-shaped turning structures C, and the turning structures C are separated from each other. For example, a first extending portion T1 and a second extending portion T2 in each turning structure C are interleaved to form the X-shaped turning structure C. In some embodiments, the second sealant pattern 220 is a meshed segmented pattern, so that the adhesion of the second sealant pattern 220 in all directions may be increased to resist the stress generated by the bending of the LCD panel 20 in different directions.

Based on the foregoing description, since the second sealant pattern has two-dimensional extending structure, the separation issue between the pixel array substrate and the opposite substrate due to the bending and distortion of the LCD panel may be alleviated. In addition, since the second sealant pattern is located outside the first sealant pattern, the one drop filling (ODF) process may have a better process window.

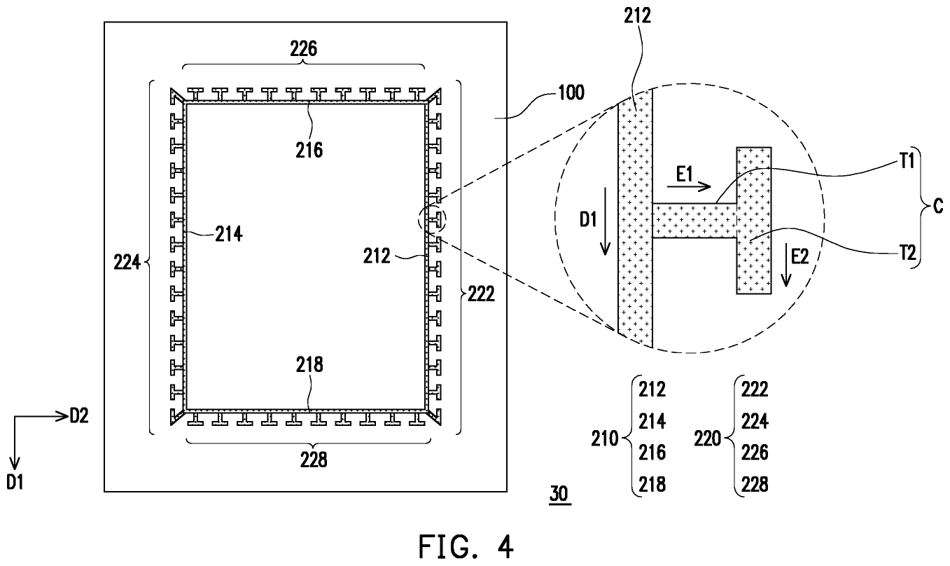

FIG. 4 is a schematic top view of an LCD panel according to an embodiment of the invention. The reference numerals and a part of the content of the embodiment in FIG. 1 are used in the embodiment of FIG. 4, in which identical or similar reference numerals indicate identical or similar components, and repeated description of the same technical content is omitted.

A difference between an LCD panel 30 in FIG. 4 and the LCD panel 10 in FIG. 1 is that turning structures C of the LCD panel 30 includes a T-shape.

Referring to FIG. 4, in this embodiment, two-dimensional extending structures 222, 224, 226 and 228 of a second sealant pattern 220 each include a plurality of T-shaped turning structures C. For example, a first extending portion T1 and a second extending portion T2 in each turning structure C are interleaved to form the T-shaped turning structure C. In this embodiment, the turning structures C are separated from each other.

In the second sealant pattern 220 of this embodiment, the turning structure C near the corner of the panel is slightly different from other turning structures C. For example, in the turning structure C near the corner of the panel, the extending direction of the first extending portion T1 may be a direction toward the corresponding corner. However, the invention is not limited thereto.

Based on the foregoing description, since the second sealant pattern has the two-dimensional extending structures, the separation issue between the pixel array substrate and the opposite substrate due to the bending and distortion of the LCD panel may be alleviated. In addition, since the second sealant pattern is located outside the first sealant pattern, the one drop filling (ODF) process may have a better process window.

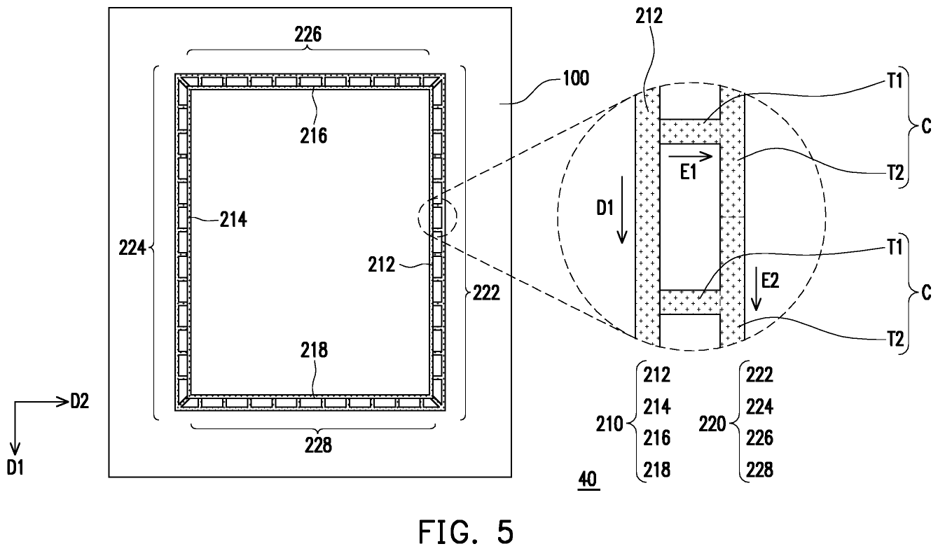

FIG. 5 is a schematic top view of an LCD panel according to an embodiment of the invention. The reference numerals and a part of the content of the embodiment in FIG. 4 are used in the embodiment of FIG. 5, in which identical or similar reference numerals indicate identical or similar components, and repeated description of the same technical content is omitted.

A difference between an LCD panel 40 in FIG. 5 and the LCD panel 30 in FIG. 4 is that a plurality of turning structures C of the LCD panel 40 are connected together.

Referring to FIG. 5, in this embodiment, two-dimensional extending structures 222, 224, 226 and 228 of a second sealant pattern 220 each include a plurality of T-shaped turning structures C. For example, a first extending portion T1 and a second extending portion T2 in each turning structure C are interleaved to form the T-shaped turning structure C. In this embodiment, the second extending portions T2 of the plurality of turning structures C are connected together, and the first extending portion T1 is connected to the second extending portion T2.

Based on the foregoing description, since the second sealant pattern has the two-dimensional extending structures, the separation issue between the pixel array substrate and the opposite substrate due to the bending and distortion of the LCD panel may be alleviated. In addition, since the second sealant pattern is located outside the first sealant pattern, the one drop filling (ODF) process may have a better process window.

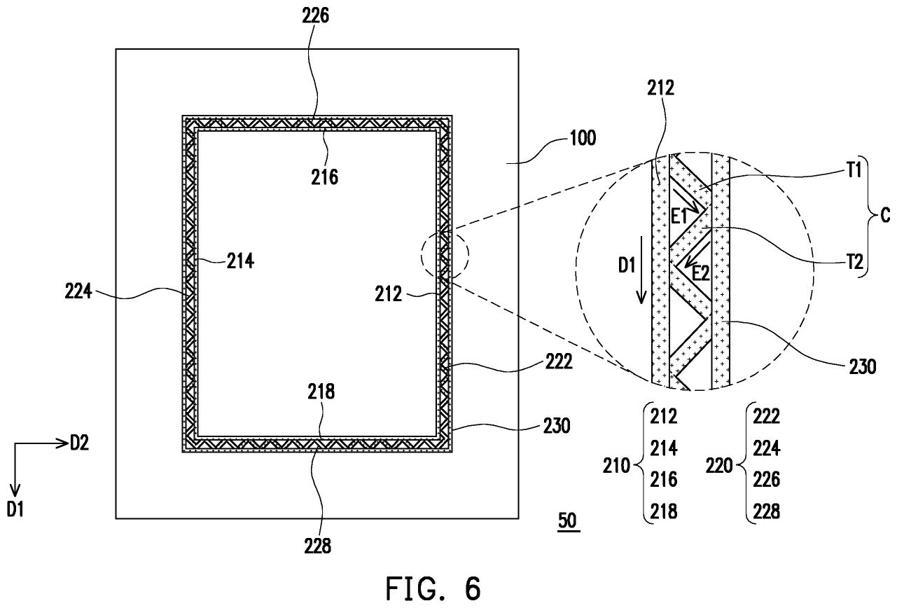

FIG. 6 is a schematic top view of an LCD panel according to an embodiment of the invention. The reference numerals and a part of the content of the embodiment in FIG. 1 are used in the embodiment of FIG. 6, in which identical or similar reference numerals indicate identical or similar components, and repeated description of the same technical content is omitted.

A difference between an LCD panel 50 in FIG. 6 and the LCD panel 10 in FIG. 1 is that the LCD panel 50 further includes a third sealant pattern 230.

Referring to FIG. 6, in this embodiment, the third sealant pattern 230 is located outside a second sealant pattern 220. The third sealant pattern 230 surrounds a first sealant pattern 210 and the second sealant pattern 220. By the configuration of the third sealant pattern 230, the stress generated by the LCD panel 50 due to bending and distortion may be further resisted so as to prevent the separation between the pixel array substrate and the opposite substrate. In this embodiment, the third sealant pattern 230 is connected to the second sealant pattern 220.

Based on the foregoing description, since the second sealant pattern has at least one two-dimensional extending structure, the separation issue between the pixel array substrate and the opposite substrate due to the bending and distortion of the LCD panel may be alleviated. In addition, since the second sealant pattern is located outside the first sealant pattern, the one drop filling (ODF) process may have a better process window.

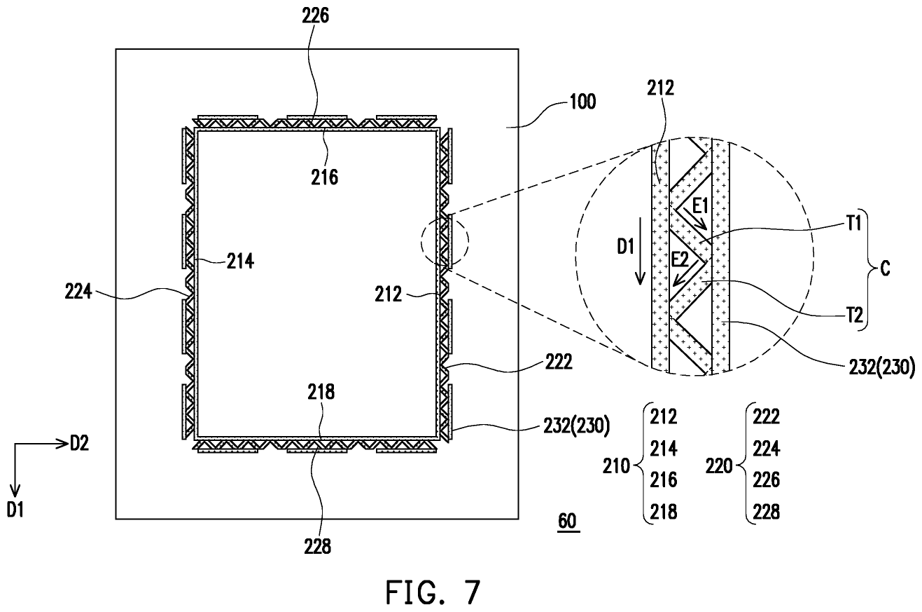

FIG. 7 is a schematic top view of an LCD panel according to an embodiment of the invention. The reference numerals and a part of the content of the embodiment in FIG. 6 are used in the embodiment of FIG. 7, in which identical or similar reference numerals indicate identical or similar components, and repeated description of the same technical content is omitted.

A difference between an LCD panel 60 in FIG. 7 and the LCD panel 50 in FIG. 6 is that a third sealant pattern 230 of the LCD panel 60 includes a plurality of line segments 232 separated from each other.

Referring to FIG. 7, in this embodiment, the third sealant pattern 230 includes the plurality of line segments 232 separated from each other. The gaps between the plurality of line segments 232 may serve as the deformation space for the third sealant pattern 230 after being bent and distorted, so that the separation issue between the pixel array substrate and the opposite substrate due to the bending and distortion of the LCD panel may be further alleviated.

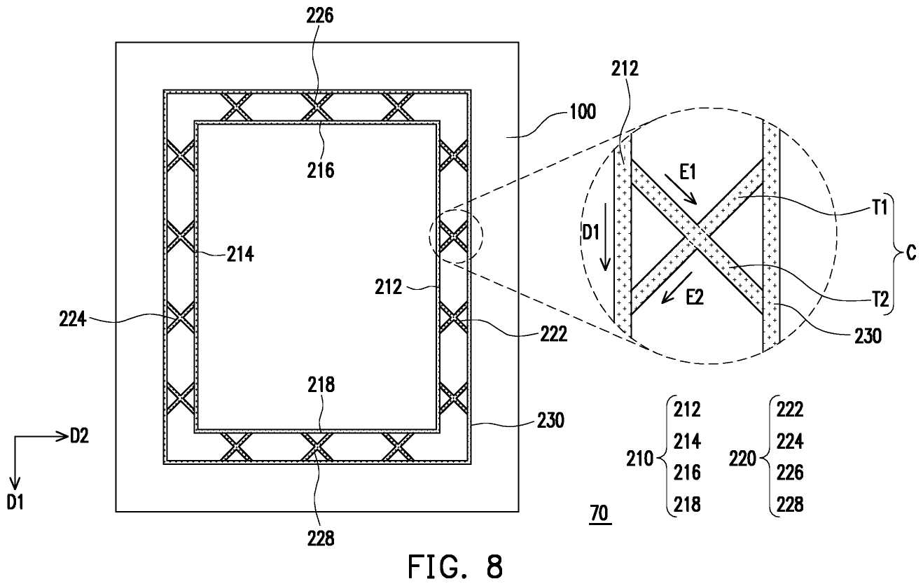

FIG. 8 is a schematic top view of an LCD panel according to an embodiment of the invention. The reference numerals and a part of the content of the embodiment in FIG. 3 are used in the embodiment of FIG. 8, in which identical or similar reference numerals indicate identical or similar components, and repeated description of the same technical content is omitted.

A difference between an LCD panel 70 in FIG. 8 and the LCD panel 20 in FIG. 3 is that the LCD panel 70 further includes a third sealant pattern 230.

Referring to FIG. 8, in this embodiment, the third sealant pattern 230 is located outside a second sealant pattern 220. The third sealant pattern 230 surrounds a first sealant pattern 210 and the second sealant pattern 220. By the configuration of the third sealant pattern 230, the stress generated by the LCD panel 70 due to bending and distortion may be further resisted so as to prevent the separation between the pixel array substrate and the opposite substrate.

Based on the foregoing description, since the second sealant pattern has at least one two-dimensional extending structure, the separation issue between the pixel array substrate and the opposite substrate due to the bending and distortion of the LCD panel may be alleviated. In addition, since the second sealant pattern is located outside the first sealant pattern, the one drop filling (ODF) process may have a better process window.

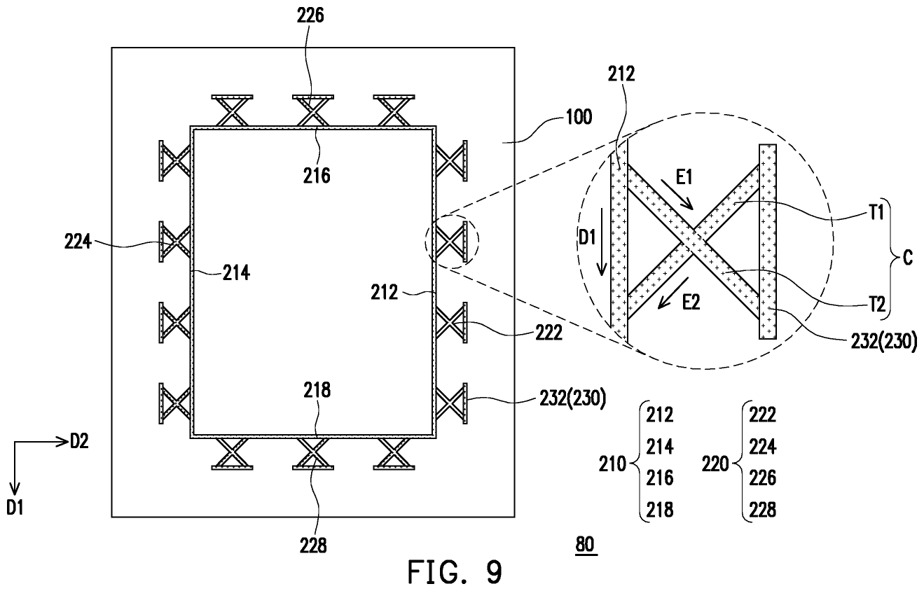

FIG. 9 is a schematic top view of an LCD panel according to an embodiment of the invention. The reference numerals and a part of the content of the embodiment in FIG. 8 are used in the embodiment of FIG. 9, in which identical or similar reference numerals indicate identical or similar components, and repeated description of the same technical content is omitted.

A difference between an LCD panel 80 in FIG. 9 and the LCD panel 70 in FIG. 8 is that a third sealant pattern 230 of the LCD panel 80 includes a plurality of line segments 232 separated from each other.

Referring to FIG. 9, in this embodiment, the third sealant pattern 230 includes the plurality of line segments 232 separated from each other. The gaps between the plurality of line segments 232 may serve as the deformation space for the third sealant pattern 230 after being bent and distorted, so that the separation issue between the pixel array substrate and the opposite substrate due to the bending and distortion of the LCD panel may be further alleviated.

Although the embodiments are already disclosed as above, these embodiments should not be construed as limitations on the scope of the invention. It will be apparent to those skilled in the art that various modifications and variations can be made to the disclosed embodiments without departing from the scope or spirit of this invention. In view of the foregoing, it is intended that the invention covers modifications and variations provided that they fall within the scope of the following claims and their equivalents.

What is claimed is:

1. A liquid crystal display panel, comprising:
a pixel array substrate having an active region and a peripheral region surrounding the active region;
a first sealant pattern surrounding the active region;
a liquid crystal layer located on the active region and located inside the first sealant pattern;
a second sealant pattern located outside the first sealant pattern, wherein the second sealant pattern comprises at least one two-dimensional extending structure, wherein the at least one two-dimensional extending structure is located outside a corresponding sidewall of the first sealant pattern and comprises a plurality of turning structures; and
an opposite substrate facing the pixel array substrate, wherein the liquid crystal layer, the first sealant pattern and the second sealant pattern are located between the pixel array substrate and the opposite substrate.

2. The liquid crystal display panel according to claim 1, wherein each of the plurality of turning structures comprises a first extending portion and a second extending portion connected to the first extending portion, and an extending direction of the first extending portion and an extending direction of the second extending portion are different from an extending direction of the corresponding sidewall.

3. The liquid crystal display panel according to claim 2, wherein the extending direction of the first extending portion forms an angle of 45 degrees with the extending direction of the corresponding sidewall, and the extending direction of the second extending portion forms an angle of 135 degrees with the extending direction of the corresponding sidewall.

4. The liquid crystal display panel according to claim 1, wherein each of the plurality of turning structures comprises an X-shape.

5. The liquid crystal display panel according to claim 1, wherein each of the plurality of turning structures comprises a T-shape.

6. The liquid crystal display panel according to claim 5, wherein the plurality of turning structures are connected together.

7. The liquid crystal display panel according to claim 1, further comprising:
a third sealant pattern located outside the second sealant pattern, wherein the third sealant pattern surrounds the first sealant pattern and the second sealant pattern.

8. The liquid crystal display panel according to claim 1, further comprising:
a third sealant pattern located outside the second sealant pattern, wherein the third sealant pattern comprises a plurality of line segments separated from each other.

9. The liquid crystal display panel according to claim 1, wherein the pixel array substrate and the opposite substrate comprise flexible substrates.
